(19) United States
(12) Patent Application Publication
(10) Pub. No.: US 2011/0235495 A1
(43) Pub. Date: Sep. 29, 2011

(54) OPTICAL HEAD AND OPTICAL RECORDING/REPRODUCING APPARATUS

(75) Inventors: Kenji Todori, Yokohama-Shi (JP); Masakazu Yamagiwa, Tokyo (JP); Ko Yamada, Yokohama-Shi (JP)

(73) Assignee: KABUSHIKI KAISHA TOSHIBA, Tokyo (JP)

(21) Appl. No.: 12/886,701

(22) Filed: Sep. 21, 2010

(30) Foreign Application Priority Data
Mar. 29, 2010 (JP) 2010-75839

(51) Int. Cl. G11B 7/135

(52) U.S. Cl. 369/112.16; G9B/7.112

(57) ABSTRACT

Certain embodiments provide an optical recording/reproducing apparatus including: a slider that has a medium facing surface that faces an optical recording medium, and moves along a recording/reproducing face of the optical recording/reproducing medium; a metal nanoparticle structure that is provided in the medium facing surface of the slider; a light illumination device that illuminates the optical recording medium and the metal nanoparticle structure with light that has polarization components in a direction perpendicular to the recording/reproducing face; and a detection device that detects Rayleigh scattering light that is generated from a portion of the optical recording medium and is intensified by the metal nanoparticle structure, the portion being located close to the metal nanoparticle structure.

### CROSS-REFERENCE TO RELATED APPLICATION

This application is based upon and claims the benefit of priority from prior Japanese Patent Application No. 2010-75839 filed on Mar. 29, 2010 in Japan, the entire contents of which are incorporated herein by reference.

### FIELD

Embodiments described herein relate to an optical head and an optical recording/reproducing apparatus using near-field light.

### BACKGROUND

An optical recording medium that is illuminated by an optical beam to reproduce information or record and reproduce information, and an optical recording apparatus that records information on such an optical recording medium have excellent compatibility with other media and excellent long-term preserving properties, compared with a HDD (Hard Disc Drive). Such an optical recording medium and an optical recording apparatus also exhibit excellent high-speed access performance, compared with magnetic tape. Therefore, such optical recording media and optical recording apparatuses are already widely used in backup memory devices for computers, image reproducing or image recording/reproducing memory devices for home use, memory devices for in-vehicle navigation systems, “Handycams”, and personal digital assistant devices, memory devices for professionals in medicine, broadcasting, and film making. Usage of such optical recording media and optical recording apparatuses is also being considered in even wider fields.

To spread optical memory devices more widely and broaden their field of application, there is a demand for a higher storage capacity and a higher data transfer rate. Conventionally, most optical memory devices are optical discs that are recording media each having a disc-like shape. This is because the high-speed access performance and the user-friendliness characteristic of the disc-like shape are preferred.

Examples of widely-used optical discs include reproduction only types such as CD-ROMs, DVD-ROMs, and BD-ROMs, recordable types such as WORMs, CD-Rs, DVD-Rs, and BD-Rs, and rewritable types such as CD-RWs, DVD-RAMs, DVD±RWs, MOs, and BD-REs. On all of those optical discs, information reproducing or recording and reproducing is performed by narrowing an optical beam almost to the diffraction limit with an objective lens, and focusing the optical beam on the recording face of the medium. Therefore, the wavelength of the light needs to be shortened, or the numerical aperture of the objective lens needs to be made larger, which is the only way, in principle, to increase the storage capacity. Other than the shortening of the wavelength and the enlargement of the numerical aperture, many techniques have been suggested, such as modulation and demodulation techniques including mark-edge recording, land-groove recording, and PRML (Partial Response Maximum Likelihood), a one-side multilayer recording technique that involves recording faces provided at different focal positions, and a super-resolution reproducing technique. However, all of those techniques employ the method for focusing an optical beam on a recording face. Therefore, the storage capacity is actually determined by the shortening of the wavelength of the light source and the enlargement of the numerical aperture.

The storage capacity has increased from 650 MB (megabytes) of a CD to 4.7 GB (gigabytes) of a DVD to 25 GB of a Blu-ray Disc. Conventional methods of increasing the capacity include: (1) achieving higher formatting efficiency; (2) improving the reproduction signal processing; (3) optimizing the medium material and structure; (4) shortening the laser light wavelength; and (5) enlarging the N. A. of the light collection optical system. Where n indicates the refractive index of the light collection optical system, and u indicates the incident angle, the N. A. is the value that is expressed as:

N.A.=n·sin(u)

In general, “the N. A. is large” is almost a parallel expression of “light is intensively collected by a large lens at a short focus”.

It is difficult to further improve the above-described items (1) through (5). To achieve a higher capacity, the use of multiple layers or holograms may be considered.

In recent years, a near-field optical recording/reproducing technique has been suggested as an optical recording method employing entirely different principles from those employed in the above-described conventional optical discs.

As research and development have become active in the field of nanophotonics, various kinds of near-field optical devices have been suggested. Particularly, with respect to surface plasmon, many kinds of suggestions have been made, in view of the effect to exceed the diffraction limit or the strong near-field interaction. The plasmon that is effective as near-field light is localized surface plasmon or surface plasmon polariton. When a metal nanostructure is illuminated by light, free electrons in the metal nanostructure oscillate with an optical electric field. In the surface of the metal nanostructure, the free electrons follow the oscillation of the optical electric field, and polarization is caused in a position on the surface of the metal nanostructure (an atomic nucleus crystalline body). In that case, electrons that oscillate in a group in the same phase are more stable in terms of energy than electrons that oscillate in different phases from one another. The oscillatory behavior in a group in the same phase is a kind of elemental excitation.

Light has high-speed properties, but has a spatial resolution of the order of half-wavelength. This is called the diffraction limit, and is the drawback of light. However, plasmon is caused by group oscillation of electrons, and therefore, does not have a diffraction limit. Although being a kind of light, plasmon can interact with a substance in an extremely small space. More specifically, plasmon can absorb, reflect, or guide a substance, for example.

Conventionally, an optical fiber is normally used to generate near-field light, but recently, attention is drawn to a phenomenon utilizing a plasmon intensified field. When plasmon concentrates on a part of a minute metal structure, the electric field intensity becomes higher by several digits, and therefore, the light emission in the vicinity of the part or a phenomenon such as Raman scattering or Rayleigh scattering is remarkably intensified. The spatial resolution in that case depends on the size of the metal nanoparticle structure or the radius of curvature of the particles. Where Rayleigh scattering light is measured with the use of a cantilever-type metal nanoparticle structure covered with Pt (platinum), a spatial resolution of 30 nm or less is obtained. Compared with intensified Raman scattering and intensified light emission, intensified Rayleigh scattering has a higher S/N ratio and a higher spatial resolution. Therefore, by using intensified Rayleigh scattering, a large-capacity optical recording apparatus can be formed.

As described above, the recording capacity of an optical recording medium is increased by carrying out the above described items (1) through (5). However, each of those items is reaching its technical limit. In reaching the limit, there is a possibility that the development costs and production costs are becoming higher and higher. Therefore, there is a demand for another mechanism for increasing the storage capacity. As a method for achieving a higher storage capacity with a mechanism other than the mechanisms mentioned in the above items, a method that involves a near-field optical fiber probe has been suggested in a stage of research. However, a near-field optical fiber probe has poor durability, and therefore, is not suitable for practical use.

### BRIEF DESCRIPTION OF THE DRAWINGS

FIG. 1 is a graph for explaining a phase change of a phase-change optical recording medium;

FIGS. 2(a) and 2(b) are drawings for explaining a recording medium having wobble grooves;

FIG. 3 is a drawing for explaining a recording medium that have periodic minute variations among the heights of the grooves formed in its surface;

FIGS. 4(a) and 4(b) show an optical recording/reproducing apparatus according to an embodiment;

FIG. 5 is a drawing for explaining the outline of an optical recording/reproducing apparatus according to an embodiment;

FIGS. 6(a) and 6(b) are drawings for explaining the shapes of metal nanoparticles;

FIG. 7 is a cross-sectional view showing an example of an optical recording medium;

FIG. 8 shows an optical recording/reproducing apparatus according to a first embodiment;

FIG. 9 shows an optical recording/reproducing apparatus according to a second embodiment;

FIG. 10 shows an optical recording/reproducing apparatus according to a third embodiment;

FIG. 11 shows an optical recording/reproducing apparatus according to a fifth embodiment; and

FIGS. 12(a) and 12(b) show an optical recording/reproducing apparatus according to a sixth embodiment.

### DETAILED DESCRIPTION

Certain embodiments provide an optical recording/reproducing apparatus including: a slider that has a medium facing surface that faces an optical recording medium, and moves along a recording/reproducing face of the optical recording/reproducing medium; a metal nanoparticle structure that is provided in the medium facing surface of the slider; a light illumination device that illuminates the optical recording medium and the metal nanoparticle structure with light that has polarization components in a direction perpendicular to the recording/reproducing face; and a detection device that detects Rayleigh scattering light that is generated from a portion of the optical recording medium and is intensified by the metal nanoparticle structure, the portion being located close to the metal nanoparticle structure.

First, the outline of the embodiments is described before embodiments are described.

The inventors developed a method for measuring refractive indexes with a spatial resolution of 20 nm to 30 nm by virtue of a plasmon intensifying effect. This method is implemented in the following manner. When a substance is illuminated by light, Rayleigh scattering is caused. For example, the spot size of a Blu-ray Disc (BD) is approximately 0.3 μm. If a metal nanoparticle structure of several tens of nanometers in size is brought closer to the substrate to be measured within the spot size, a larger amount of Rayleigh scattering light is generated from the substance to be measured. The increased Rayleigh scattering light is measured to detect a change in refractive index. In an embodiment, a metal nanoparticle structure is mounted on an optical head, and a refractive-index variation in the medium surface is detected by virtue of the above mentioned plasmon intensifying effect.

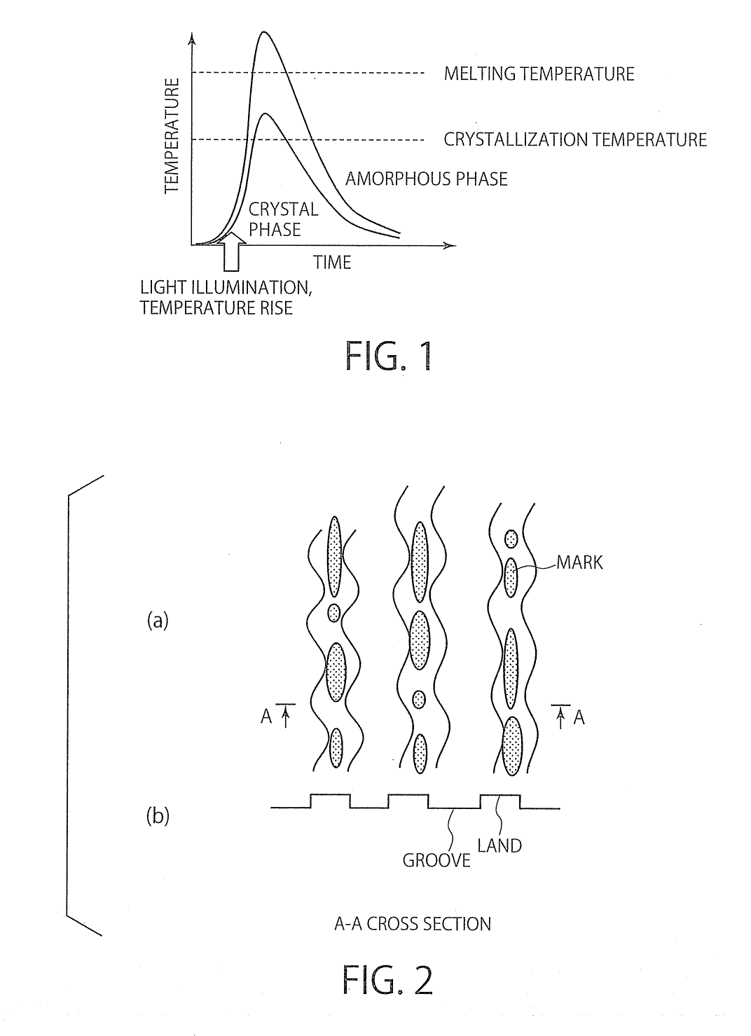

An optical recording medium is normally a phase-change medium. Phase-change media are used for DVDs and BDs. The materials that can be used for phase-change media include GeSbTe. A phase change is caused between a crystal phase and an amorphous phase by light illumination power, and recording signals are recorded and reproduced by the differences in complex refractive index. As for the recording, where the temperature is raised to the melting temperature by light illumination, an amorphous phase is obtained. Where the temperature is raised from the crystallization temperature to the melting temperature, a crystal phase is obtained as shown in FIG. 1.

Other than the phase-change recording method, a method for performing recording on molecules, such as an optical refractive-index change method or photochromism, may be implemented. If one mark can be recorded on each one molecule, the recording capacity can be dramatically increased. If a metal layer exists below the recording layer, the plasmon intensifying effect is made greater, and the S/N ratio becomes higher accordingly. Therefore, a medium to be used in an embodiment should preferably have a metal layer provided below the recording layer. Since such a metal layer is sensitive to dust and finger prints, the medium should be put into a package and protected.

To achieve higher sensitivity, tapping of a metal nanoparticle structure or a lock-in amplifier is being studied for the use in reproducing operations. In an embodiment, however, a read IC is used in practice, and sufficient reading can be performed, without any of the above units (tapping or a lock-in amplifier).

As shown in FIGS. 2(a) and 2(b), wobble grooves may be employed as the grooves of a recording medium, and higher sensitivity can be achieved by obtaining synchronization with the frequency of the wobble grooves. If there are grooves having the same cycles as one another within the spot size, noise might be caused. Therefore, adjacent wobble grooves within the spot size should preferably have different cycles from one another, even if only slightly, to achieve a higher S/N ratio. FIG. 2(a) is a plan view of a recording medium that has wobble grooves as its grooves. FIG. 2(b) is a cross-sectional view of the recording medium, taken along the line A-A of FIG. 2(a).

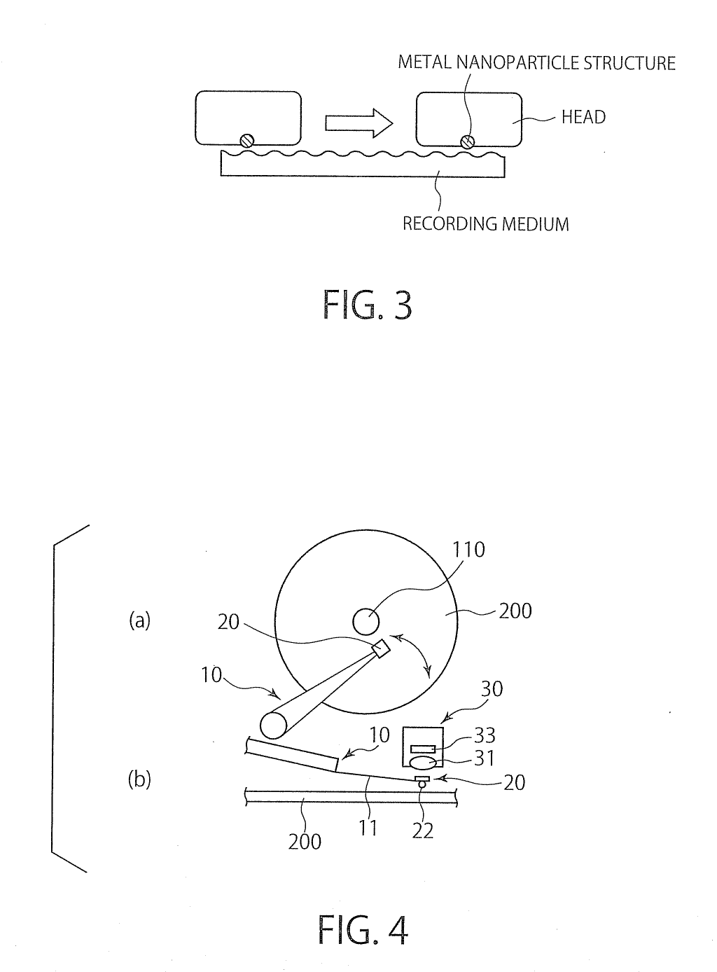

Instead of wobble grooves, as shown in FIG. 3, periodic minute variations may be formed in the groove height in the medium surface, to achieve the same effects as above. This is equivalent to tapping in a near-field optical microscope. When signals are amplified in synchronization with the frequency, the S/N ratio becomes higher, and marks with smaller mark lengths can be read.

An optical recording/reproducing apparatus of one embodiment may have the structure illustrated in FIGS. 4(a) and 4(b), for example. This optical recording/reproducing apparatus includes an arm 10. This arm 10 has a suspension 11 that has one end fixed, and a slider 20 is attached to the other end of the suspension 11. The arm 10 is controlled by a control device (not shown) so that the slider 20 follows a desired position on the recording/reproducing face of a medium 200 rotating about a rotating shaft 110. As shown in FIG. 4(b), a metal nanoparticle structure 22 is provided on the side of the slider 20 facing the medium 200. The recording/reproducing apparatus also includes a light illumination device 30 that illuminates the recording/reproducing face of the medium 200 with light. This light illumination device 30 includes a Z-polarization plate 33 that Z-polarizes light emitted from a light source (not shown), and a collecting lens 31 that collects the light having passed through the Z-polarization plate on the recording/reproducing face of the medium 200. When the light having passed through the collecting lens 31 is incident on the medium 200, plasmon is generated from the surface of the metal nanoparticle of the metal nanoparticle structure 22, and Rayleigh scattering light is generated from the surface of the medium 200. The Rayleigh scattering light is intensified by the plasmon.

Meanwhile, reflected light is generated from the medium 200, and hinders an increase of sensitivity. Therefore, it is preferable to design such a structure that the reflected light can be spatially distinguished from the Rayleigh scattering light. In other words, it is preferable to place a detector for detecting the Rayleigh scattering light in a position where the reflected light cannot reach.

In this embodiment, the plasmon intensifying effect of the metal nanoparticle structure is used, and therefore, there is no need to use a near-field optical fiber. The metal nanoparticle structure 22 should be simply buried in the face (the medium facing surface) of the slider 20 made of a dielectric material on the side of the recording medium. The medium facing surface of the slider 20 is even with the recording/reproducing face of the recording medium 200 during each operation. Accordingly, the probability that the metal nanoparticle structure 22 is brought into contact with the medium 200 during an operation becomes lower, and high durability can be secured.

Where incident light or Rayleigh scattering light passes through the slider 20, the material of the slider 20 needs to be transparent at the corresponding wavelength. In spite of polarized incident light, the components perpendicular to the medium facing surface, which is the reading face of the slider 20, cause a Rayleigh scattering intensifying effect. To efficiently increase the perpendicular components, (1) light should be incident horizontally or obliquely, (2) light should be guided to the metal nanoparticle structure 22 through a fiber, a waveguide, or a near-field optical waveguide, or (3) a Z-polarization plate should be used.

JP-A 2000-268394 (KOKAI) discloses a near-field optical memory head to which an aperture-type near-field probe is applied. However, an aperture type normally has a poor spatial resolution. If the aperture size is made smaller to increase the spatial resolution, the efficiency of conversions to near-field light becomes extremely low.

On the other hand, the embodiment employs a system of a non-aperture type or a scattering type, and provides a higher spatial resolution and a higher S/N ratio than those of an aperture type.

JP-A 2008-305501 and 2008-293580 (KOKAI) disclose optical heads for optically-assisted magnetic recording to which near-field light is applied. However, only polarization components perpendicular to the medium can obtain Rayleigh scattering light to increase the S/N ratio. Therefore, the structure according to the embodiment can increase the spatial resolution with higher efficiency.

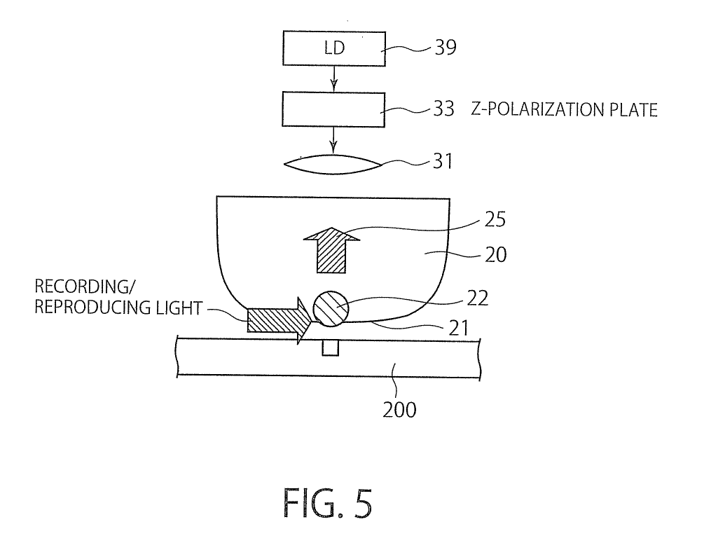

Referring now to FIG. 5, the fundamental structure of the optical recording/reproducing apparatus according to the embodiment is described.

The required fundamental structure preferably includes a light source (such as a laser diode) 39 that emits light, a detector (not shown) that detects Rayleigh scattering light from the medium 200; the metal nanoparticle structure 22; the slider 20 that has the metal nanoparticle structure 22 provided in the medium facing surface 21; a structure (such as an optical waveguide or a Z-polarization plate) 33 that illuminates the recording/reproducing face of the medium 200 with perpendicularly polarized light; a structure (not shown) that prevents reflected light from entering the detector; the lens 31 that collects light on the medium 200; and a reproduction logic circuit (not shown). The lens 31 may not be provided, and the slider 20 may also serve as a lens.

As the spot size of the light (laser light) incident on the medium 200 becomes smaller, the noise signal becomes also smaller. This is because there are noise components that are determined by the ratio between the size of the metal nanoparticle structure 22 and the spot size. Also, as the metal nanoparticle structure 22 becomes smaller, the reproducible recording capacity of the medium 200 becomes larger, but noise also becomes larger. More specifically, the spot size of laser light is approximately 250 nm to 800 nm, and the size of a metal nanoparticle structure is approximately 10 nm to 100 nm. More preferably, the size of the metal nanoparticle structure is 20 nm to 50 nm, in view of the S/N ratio and resolution. However, where the illumination spot size is made smaller, marks of smaller sizes can be recorded or reproduced while the S/N ratio is maintained. The ratio of the metal nanoparticle structure to the laser spot size is in the range of 0.01 to 0.4, or more preferably, in the range of 0.08 to 0.15.

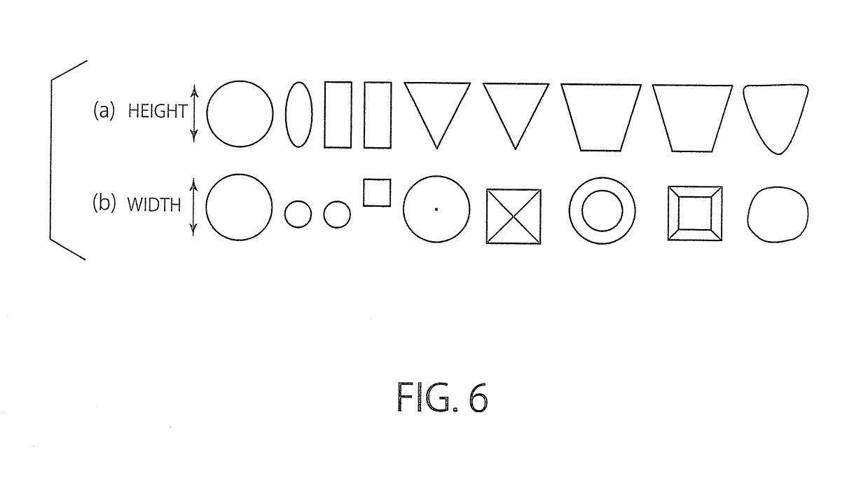

Preferable examples of materials that can be used for the metal nanoparticle structure 22 include gold, silver, aluminum, chromium, copper, and nickel, though gold and silver are particularly preferable. As shown in FIGS. 6(a) and 6(b), the metal nanoparticle structure may be in a sphere-like form or a stick-like form, having a shape like a sphere, an oval sphere, a circular cylinder, a circular cone, a rectangular column, a pyramid, a truncated pyramid, or a shape similar to any of those. FIG. 6(a) shows cross-sectional views of metal nanoparticle structures 22, each taken along a plane substantially perpendicular to the medium facing surface 21 of the slider 20. FIG. 6(b) shows plan views of the metal nanoparticle structures 22, seen from the recording medium 200. The section size of the portion closest to the recording medium 200 should preferably be the smallest. The metal nanoparticle structure 22 should preferably be 10 nm to 500 nm in height, 100 nm or less in minimum width, and 10 nm to 500 nm in maximum width. The minimum width or the size of the metal nanoparticle structure 22 on the side of the recording medium represents the recording and reproducing resolution capability.

Also, it is preferable to provide a logic function that reads signals synchronous with wobble groove signals being reproduced by the metal nanoparticle structure, with the wobble cycles varying in the medium within the incidence spot size.

The slider 20 is used in a hard disc drive (HDD), and the distance between the slider 20 and a HDD recording medium during an operation is approximately 10 nm. This distance is maintained by virtue of the viscosity of the air. In this embodiment, the same distance is maintained between the medium 200 and the slider 20, but the metal nanoparticle structure 22 is closer to the medium 200 than the slider 20 to the medium 200, by the length of the portion of the metal nanoparticle structure 22 sticking out of the medium facing surface 21 of the slider 20. The minimum distance between the metal nanoparticle structure 22 and the medium 200 is in the range of 0.5 nm to 5 nm, or more preferably, in the range of 1 nm to 3 nm. The size of the slider 20 is 2 mm or smaller, or more preferably, 1 mm or smaller, like a HDD. Since the material of the slider 20 needs to transmit light, the slider 20 should be made of a transparent material, such as glass or a plastic material like PMMA or polystyrene.

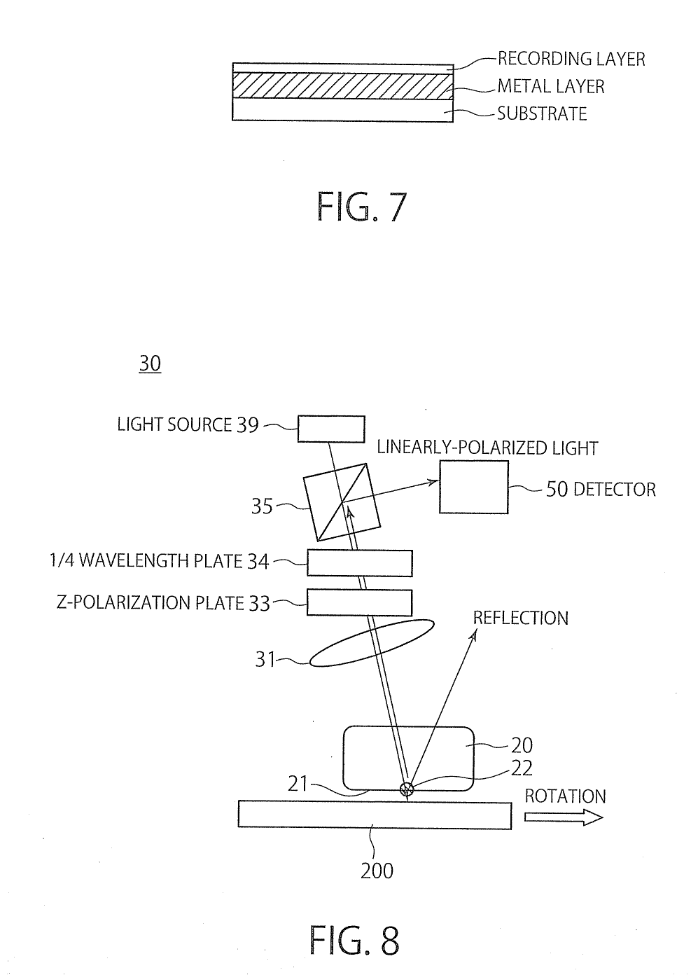

The medium 200 simply has its recording face as the uppermost face, and does not have a cover layer. The medium 200 may have a structure formed by placing a single recording layer directly on a substrate. However, as shown in FIG. 7, it is preferable to provide a metal layer below a recording layer, so as to intensify the electromagnetic field. Also, a thermal conduction adjustment layer may be placed in the vicinity of a recording layer or a metal layer.

### First Embodiment

FIG. 8 shows an optical recording/reproducing apparatus according to a first embodiment. The optical recording/reproducing apparatus of the first embodiment includes a slider 20, a metal nanoparticle structure 22 that is provided in the medium facing surface 21 of the slider 20, a light illumination device 30, and a detector 50 that detects Rayleigh scattering light generated from a recording medium 200. The light illumination device 30 includes a collecting lens 31, a Z-polarization plate 33, a ¼ wavelength plate 34, a polarization beam splitter 35, and a light source 39. As the light source 39, it is preferable to use a laser diode that emits a laser beam, for example. The laser beam emitted from the laser diode 39 enters the collecting lens 31, after passing through the polarization beam splitter 35, the ¼ wavelength plate 34, and the Z-polarization plate 33. Having passed through the collecting lens 31, the laser beam passes through the slider 20, and is collected onto a predetermined position on the recording/reproducing face of the optical recording medium 200. Plasmon is then generated from the surface of the metal nanoparticle of the metal nanoparticle structure 22, and Rayleigh scattering light is generated from the surface of the optical recording medium 200. The Rayleigh scattering light is intensified by the plasmon. The intensified Rayleigh scattering light enters the polarization beam splitter 35, after passing through the slider 20, the collecting lens 31, the Z-polarization plate 33, and the ¼ wavelength plate 34. Having entered the polarization beam splitter 35, the Rayleigh scattering light is polarized to be linearly-polarized light, and is separated. The Rayleigh scattering light is then sent to the Rayleigh scattering light detector 50. Here, the light illumination device 30 is placed in such a position that the laser beam reflected by the optical recording medium 200 does not pass through the collecting lens 31, the Z-polarization plate 33, and the ¼ wavelength plate 34.

The material of the slider 20 is SiO₂. A hole is formed in the recording/reproducing face (the medium facing surface) of the slider 20 with a FIB (Focused Ion Beam), and a gold nanoparticle of 50 nm in size (diameter) is half-buried in the hole. To move and bury the gold particle, optical tweezers are used. A 20-nm SiO₂ film is lightly vapor-deposited over the gold particle. After that, the SiO₂ film is shaved off with a FIB, so that the top end of the gold nanoparticle is exposed. The wavelength of the laser light emitted from the light source 39 is 532 nm. The material of the recording layer of the optical recording medium 200 is GeSbTe (30 nm in film thickness). The recording light power is approximately 4 mW, and the reproducing light power is 0.5 mW. The optical recording medium 200 is a medium that is formed by placing a gold layer of 50 nm in film thickness on a polycarbonate substrate of 1.2 mm in thickness, and placing a Ge₂Sb₂Te₅ layer of 30 nm in film thickness as the recording layer on the gold layer. Wobble grooves are formed in the optical recording medium 200. A lock-in amplifier is synchronized with a wobble frequency of 2 MHz, while a check is made with a spectrum analyzer, instead of a reproducing IC chip. In this manner, reproduction signals are read. At this point, the length of each mark that can be recorded or reproduced is approximately 25 nm.

Where a silver nanoparticle is used, instead of a gold nanoparticle, almost the same signals as above can be obtained. Where a particle of aluminum, chromium, copper, or nickel is used, instead of a gold nanoparticle, the S/N ratio becomes lower, and the minimum mark length becomes as large as approximately 50 nm.

As described above, according to this embodiment, the Rayleigh scattering light generated from a medium is intensified by a metal nanoparticle structure, and the intensified Rayleigh scattering light is detected. Accordingly, the recording capacity of the recording medium can be increased.

### Second Embodiment

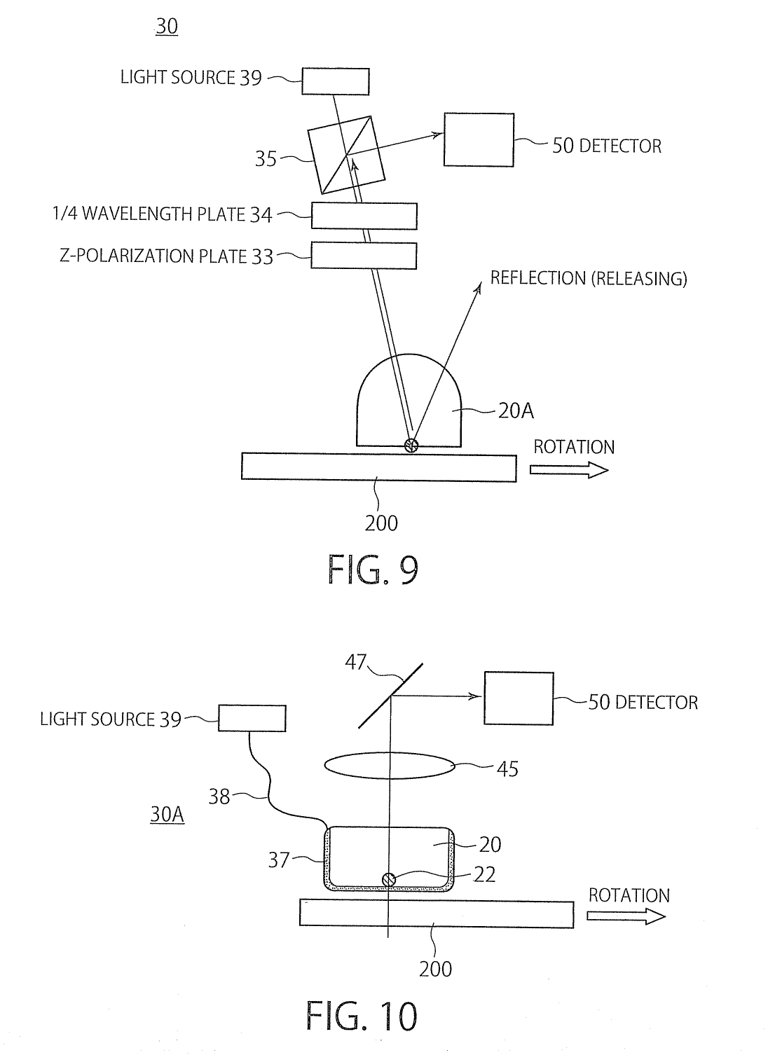

FIG. 9 shows an optical recording/reproducing apparatus according to a second embodiment. This optical recording/reproducing apparatus of the second embodiment is the same as the optical recording/reproducing apparatus of the first embodiment illustrated in FIG. 8, except that the collecting lens 31 is eliminated, and the slider 20 has a lens function. Specifically, the incidence plane of the slider 20 made of SiO₂ forms a lens structure. In this case, a SILL (Solid Immersion Lens) effect is also achieved. Accordingly, the N. A. becomes larger, and the incidence spot size becomes smaller. As a result, the S/N ratio becomes higher.

The length of the minimum mark that can be recorded and reproduced in this case is 20 nm, which is slightly smaller than that in the first embodiment.

In the second embodiment, the Rayleigh scattering light generated from a medium is intensified by a metal nanoparticle structure, and the intensified Rayleigh scattering light is detected, as in the first embodiment. Accordingly, the recording capacity of the recording medium can be increased.

### Third Embodiment

FIG. 10 shows an optical recording/reproducing apparatus according to a third embodiment. This optical recording/reproducing apparatus of the third embodiment includes a light illumination device 30A, a slider 20, a metal nanoparticle structure 22 that is provided in the medium facing surface of the slider 20, a lens 45, a mirror 47, and a detector 50 that detects Rayleigh scattering light. The light illumination device 30A includes a light source (a laser diode) 39 that emits laser light, an optical fiber 38 through which the laser light emitted from the laser diode 39 propagates, and a light propagation waveguide 37 provided on the medium facing surface of the slider 20. Since the light propagation waveguide 37 is provided on the medium facing surface of the slider 20 in the third embodiment, perpendicularly polarized light can enter the reproducing face of an optical recording medium.

The laser light emitted from the laser diode 39 passes through the optical fiber 38, and is sent to the light propagation waveguide 37. Here, the polarized light obtained at the metal nanoparticle structure 22 polarizing the laser light emitted from the laser diode 39 is adjusted to be perpendicular to the recording/reproducing face (the medium facing surface) of the slider 20. With this arrangement, reflected light of incident light does not enter the detector 50. Since light is released from the end faces of the light propagation waveguide 37, the end faces of the light propagation waveguide 37 should be positioned away from the metal nanoparticle structure 22. The light propagation waveguide 37 has a core width of 1 μm and a cladding width of 125 μm. The Rayleigh scattering light that is generated from the optical recording medium 200 and is intensified by the metal nanoparticle structure 22 passes through the slider 20 and the lens 45, and is then reflected by the mirror 47. The Rayleigh scattering light reflected by the mirror 47 is detected by the detector 50. The length of the minimum recording/reproducing mark in the third embodiment is 30 nm.

In the third embodiment, the Rayleigh scattering light generated from a medium is intensified by a metal nanoparticle structure, and the intensified Rayleigh scattering light is detected, as in the first embodiment. Accordingly, the recording capacity of the recording medium can be increased.

### Fourth Embodiment

Next, an optical recording/reproducing apparatus according to a fourth embodiment is described. This optical recording/reproducing apparatus of the fourth embodiment is the same as the optical recording/reproducing apparatus of the third embodiment, except that a near-field optical waveguide is used as the light propagation waveguide 37. In this near-field optical waveguide, gold nanoparticles are scattered. The method for manufacturing the near-field optical waveguide is now described. First, a groove that is 100 nm in width and 100 nm in depth is formed in the surface of the slider 20 with a FIB. Gold nanoparticles that have oleylamine as ligands and each have a core-shell structure of approximately 10 nm in core diameter are applied onto the surface. After that, the gold nanoparticles of the core-shell structures located outside the groove are removed by mechanical polishing. A hole is then formed in the recording/reproducing face (the medium facing surface) of the slider 20 with a FIB, and a gold nanoparticle of 50 nm in size is half-buried in the hole. To move and bury the gold, optical tweezers are also used as in the first embodiment. A 20-nm SiO₂ film is lightly vapor-deposited over the gold particles. After that, the SiO₂ film is shaved off, so that only the top end of the gold nanoparticle is exposed. The incidence on the near-field optical waveguide is transferred to the incident optical fiber 38 via a spot size converter. Other than a waveguide structure using core-shell metal nanoparticles, it is possible to use a silver nanoparticle scattering material or a metal thin-wire plasmon waveguide utilizing a sol-gel method. In this case, the length of the minimum recording/reproducing mark is also 30 nm.

In the fourth embodiment, the Rayleigh scattering light generated from a medium is intensified by a metal nanoparticle structure, and the intensified Rayleigh scattering light is detected, as in the first embodiment. Accordingly, the recording capacity of the recording medium can be increased.

### Fifth Embodiment

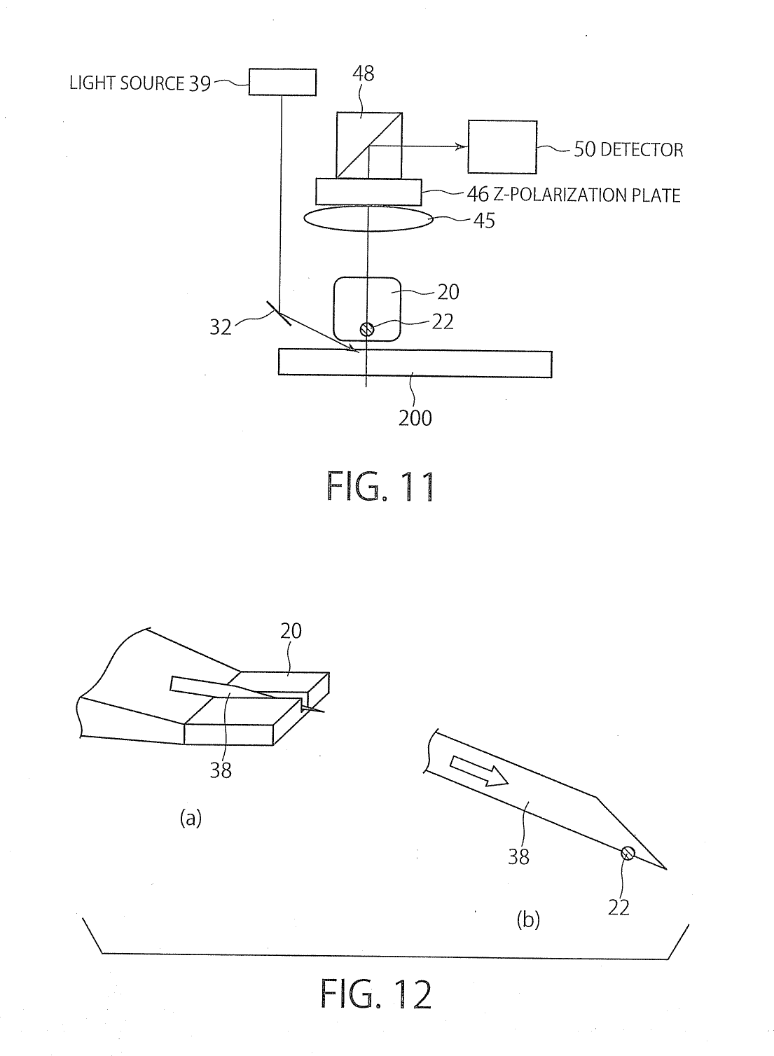

FIG. 11 shows an optical recording/reproducing apparatus according to a fifth embodiment. This optical recording/reproducing apparatus of the fifth embodiment is designed so that light is incident from a side, since incident light is polarized perpendicularly to the recording/reproducing face (the medium facing surface) of the slider 20. Specifically, laser light emitted from a laser diode 39 is reflected by a mirror 32, and is incident on an optical recording medium 200 from a side of the slider 20. The Rayleigh scattering light that is generated from the optical recording medium 200 and is intensified by a metal nanoparticle structure 22 passes through the slider 20, a lens 45, and a Z-polarization plate 46. The Rayleigh scattering light is then separated by a polarization beam splitter 48, and is sent to and detected by a detector 50. In the fifth embodiment, a minimum recording mark of 80 nm in length can be read.

In the fifth embodiment, the Rayleigh scattering light generated from a medium is intensified by a metal nanoparticle structure, and the intensified Rayleigh scattering light is detected, as in the first embodiment. Accordingly, the recording capacity of the recording medium can be increased.

### Sixth Embodiment

FIGS. 12(a) and 12(b) show an optical recording/reproducing apparatus according to a sixth embodiment. This optical recording/reproducing apparatus of the sixth embodiment is designed so that the top end of an optical fiber 38 for propagating the laser light emitted from a laser diode (not shown) serves as a slider (FIG. 12(a)). In this structure, the top end of a regular optical fiber is cut obliquely with respect to the recording/reproducing face, and is fixed to a slider housing 20. This is different from a near-field fiber that is easily bent.

A hole is formed at the top end of the optical fiber 38 with a FIB, and a silver nanoparticle 22 of 50 nm in diameter is buried in the hole. After that, sputtering is performed with SiO₂, and FIB cutting is further performed so that the surface of the silver nanoparticle 22 is exposed through the surface of the optical fiber 38 (FIG. 12(b)). FIG. 12(b) is an enlarged view of the top end of the optical fiber 38. The length of the portion of the silver nanoparticle 22 protruding from the lower face of the slider is 5 nm. In the sixth embodiment, the minimum recording/reproducing mark length is also 30 nm.

In the sixth embodiment, the Rayleigh scattering light generated from a medium is intensified by a metal nanoparticle structure, and the intensified Rayleigh scattering light is detected, as in the first embodiment. Accordingly, the recording capacity of the recording medium can be increased.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical recording/reproducing apparatus comprising:
a slider that has a medium facing surface that faces an optical recording medium, and moves along a recording/reproducing face of the optical recording/reproducing medium;
a metal nanoparticle structure that is provided in the medium facing surface of the slider;
a light illumination device that illuminates the optical recording medium and the metal nanoparticle structure with light that has polarization components in a direction perpendicular to the recording/reproducing face; and
a detection device that detects Rayleigh scattering light that is generated from a portion of the optical recording medium and is intensified by the metal nanoparticle structure, the portion being located close to the metal nanoparticle structure.

2. The apparatus according to claim 1, wherein the slider has a lens function that collects the light onto the recording/reproducing face of the optical recording medium.

3. The apparatus according to claim 1, wherein
the light illumination device includes:
a light source that emits the light;
a polarization beam splitter that transmits the light emitted from the light source;
a ¼ wavelength plate that receives light from the polarization beam splitter; and
a Z-polarization plate that receives light from the ¼ wavelength plate, sends the light from the ¼ wavelength plate to the slider and the metal nanoparticle structure, and sends the intensified Rayleigh scattering light to the ¼ wavelength plate,
the ¼ wavelength plate sends the Rayleigh scattering light sent from the Z-polarization plate to the polarization beam splitter, and
the polarization beam splitter sends the Rayleigh scattering light sent from the ¼ wavelength plate to the detection device.

4. The apparatus according to claim 1, wherein
the light illumination device includes:
a light source that emits the light;
an optical fiber that propagates the light emitted from the light source; and
a light propagation waveguide that is provided in the medium facing surface of the slider, and propagates the light propagated through the optical fiber, and
the detection device includes:
a lens that collects the intensified Rayleigh scattering light sent from the slider;
a mirror that reflects the Rayleigh scattering light collected by the lens; and
a detector that detects the Rayleigh scattering light reflected by the mirror.

5. The apparatus according to claim 4, wherein the light propagation waveguide is a near-field optical waveguide.

6. The apparatus according to claim 1, wherein
the light illumination device includes:
a light source that emits the light; and
a mirror that reflects the light emitted from the light source and illuminates the metal nanoparticle structure and the optical recording medium with the light, and
the detection device includes:
a lens that collects the intensified Rayleigh scattering light sent from the slider;
a Z-polarization plate that receives the Rayleigh scattering light collected by the lens;
a mirror that reflects the Rayleigh scattering light sent from the Z-polarization plate; and
a detector that detects the Rayleigh scattering light reflected by the mirror.

7. The apparatus according to claim 1, wherein
the light illumination device includes:
a light source that emits the light; and
an optical fiber that propagates the light emitted from the light source, and
a top end of the optical fiber serves as the slider.
